(19) United States
(12) Patent Application Publication
(10) Pub. No.: US 2022/0374459 A1
(43) Pub. Date: Nov. 24, 2022

(54) SYSTEMS AND METHODS FOR HIERARCHICAL RETRIEVAL OF SEMANTIC-BASED PASSAGES IN DEEP LEARNING

(71) Applicant: salesforce.com, inc., San Francisco, CA (US)

(72) Inventors: Ye Liu, Chicago, IL (US); Kazuma Hashimoto, Menlo Park, CA (US); Yingbo Zhou, Palo Alto, CA (US); Semih Yavuz, Redwood City, CA (US); Caiming Xiong, Menlo Park, CA (US)

(21) Appl. No.: 17/533,613

(22) Filed: Nov. 23, 2021

Related U.S. Application Data
(60) Provisional application No. 63/189,505, filed on May 17, 2021.

(51) Int. Cl. G06F 16/335; G06F 16/332; G06F 16/31

(52) U.S. Cl. CPC G06F 16/337; G06F 16/3329; G06F 16/313

(57) ABSTRACT

Embodiments described herein provide a dense hierarchical retrieval for open-domain question and answering for a corpus of documents using a document-level and passage-level dense retrieval model. Specifically, each document is viewed as a structural collection that has sections, subsections and paragraphs. Each document may be split into short length passages, where a document-level retrieval model and a passage-level retrieval model may be applied to return a smaller set of filtered texts. Top documents may be identified after encoding the question and the documents and determining document relevance scores to the encoded question. Thereafter, a set of top passages are further identified based on encoding of the passages and determining passage relevance scores to the encoded question. The document and passage relevance scores may be used in combination to determine a final retrieval ranking for the documents having the set of top passages.

### CROSS REFERENCES

The instant application is a nonprovisional of and claims priority under 35 U.S.C. § 119 to co-pending and commonly-owned U.S. provisional application No. 63/189,505, filed May 17, 2021, which is hereby expressly incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The embodiments relate generally to machine learning systems and deep learning, and more specifically to a hierarchical retrieval framework of semantic-based data.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Machine learning (ML) and neural network (NN) systems may be utilized to attempt to understand human speech and writing, e.g., to understand the overall intent, syntax, and/or semantics of human communication. Such ML/NN systems may be trained using a large amount of training text, including different corpora of documents, that are pre-annotated with labels (supervised), or without pre-annotated labels (unsupervised). When training ML systems, different training data may be utilized, including characters, words, phrases, passages, and content from documents. However, training data, and specification of such data, varies in scope, which may cause different predictions and classifications when using large corpora of documents. Further, different uses of training data having different documents, passages from documents, and the like may result in unpredictable and/or slower search results once an ML/NN model is trained.

Recent studies on dense neural retrievers achieve promising results on open-domain Question Answering (QA) by ML/NN systems, where latent representations of questions and passages may be exploited for maximum inner product search in the retrieval process. However, training dense retrievers require splitting documents into short passages whose representations may contain local, partial and sometimes biased content, and therefore training is highly dependent on the splitting process. As a consequence, the training may yield inaccurate and misleading hidden representations in the model, thus deteriorating the final retrieval result by the ML/NN system.

### BRIEF DESCRIPTION OF THE DRAWINGS

FIG. 1 illustrates a block diagram of an example environment wherein systems and methods for predicting database query results may be used according to some embodiments.

FIG. 2 illustrates a block diagram of another example environment according to some embodiments.

FIG. 3 illustrates a block diagram of an exemplary computing system for retrieving documents and passages using a hierarchical retrieval in deep learning according to some embodiments.

FIG. 4 illustrates a simplified diagram of an exemplary document and passages in a corpus of documents that may be retrieved using hierarchical retrieval of semantic-based passages in deep learning according to some embodiments.

FIG. 5 illustrates a simplified diagram of exemplary components for hierarchical retrieval of semantic-based passages in deep learning according to some embodiments.

FIG. 6 illustrates a simplified diagram of a flowchart for hierarchical retrieval of semantic-based passages in deep learning using a document-level and passage-level retriever described in FIGS. 3, 4, and 5 according to some embodiments.

In the figures, elements having the same designations have the same or similar functions.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one skilled in the art. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Deep learning has been widely used in ML and NN systems. In contrastive learning, open-domain QA may be used to answer a factoid question. Previously, dense passage retrieval may be used for answering a question. One of the prevalent approaches is to utilize a retriever-reader approach to provide an answer. In such open-domain question answering, a question is given and a set of relevant contexts within a corpus of documents is predicted. However, extracting relevant contexts from a large corpus of documents, such as Wikipedia, is difficult and suffers from weaknesses, such as where similar topics may be related to a particular question. Further, passages from documents may contain only local and specific information, leading to distracting representations.

Instead, a Dense Hierarchical Retrieval (DHR) may be used to generate accurate dense representations of passages by utilizing both macroscopic semantics in the document and microscopic semantics specific to each passage. First, relevant documents to a question are retrieved, for example, based on encoding documents from a corpus of documents. Documents may be encoded at a document level using their abstracts, table of contents, and/or other table of titles within the documents. Thereafter, relevant passages may be retrieved by a passage-level retrieval model that is calibrated with document-level relevance. To further enhance the global semantics, each passage is combined with a hierarchical title list. To better learn the positive passages, two negative sampling strategies may be introduced, i.e., in-document (in-Doc) negative and in-section (in-Sec) negative samples may be used as hard contrastive samples. DHR is applied to large open-domain QA datasets, where a dense hierarchical retrieval model may outperform a dense passage retriever and help end-to-end QA systems establish better results on multiple open-domain QA benchmarks.

As used herein, the term “network” may comprise any hardware or software-based framework that includes any artificial intelligence network or system, NN or system, and/or any training or learning models implemented thereon or therewith.

As used herein, the term “module” may comprise any hardware or software-based framework that performs one or more functions. In some embodiments, the module may be implemented on one or more NNs.

### Overview

For a database system accessible by a plurality of separate organizations, such as a multi-tenant database system, methods, data structures, and systems are provided for processing a corpus of documents using a document-level retrieval model and a passage-level retrieval model. The database system stores multiple documents that are accessible by users of the database system, referred to as a corpus of documents or corpora of documents. The documents may be generated, for example, by users or administrators (e.g., agents of an organization) of the database systems based on input, articles, requests, and other documents that may provide some information, such as informational articles, encyclopedic entries, help request, training manuals, pamphlets or other articles about a subject that provide information. At least some documents stored by the database system are associated with passages having relevant text for the document title or subject. A document within a corpus of documents may further include one or more document structures, including an abstract, a table of contents (ToC), sections and corresponding section titles, subsections and corresponding subsection titles, tables of titles, paragraphs, sentences, and/or other text.

The embodiments described herein provide methods, computer program products, and computer database systems for hierarchical retrieval of semantic-based passages from documents using a document-level retrieval model and a passage-level retrieval mode that employ ML and NN techniques. An online system provides users with access to online services and corpora of documents. For example, the online system may be a web-based system that provides users with access to encyclopedic resources and/or customer relationship management (CRM) software applications. As part of providing the services to users, the online system stores the corpora of documents that are accessible by users of the online system and searchable using a trained ML/NN process and/or other search engine, such as a natural language processor. The corpora of documents may be generated, for example, by users or administrators of the online system based on input and identification of documents.

According to some embodiments, in a multi-tenant database system accessible by a plurality of separate and distinct organizations, a neural network model is provided for processing a corpus of documents and providing relevant semantic-based passages using DHR, taking into account the specificities of each document, document structure, and passage, thereby enhancing the experience of users associated with the organization, providing faster retrieval results, and minimizing at time processing costs for text retrieval.

### Example Environment

The system and methods of the present disclosure can include, incorporate, or operate in conjunction with or in the environment of a database, which in some embodiments can implemented as a multi-tenant, cloud-based architecture. Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost-effective sharing of similar application features between multiple sets of users.

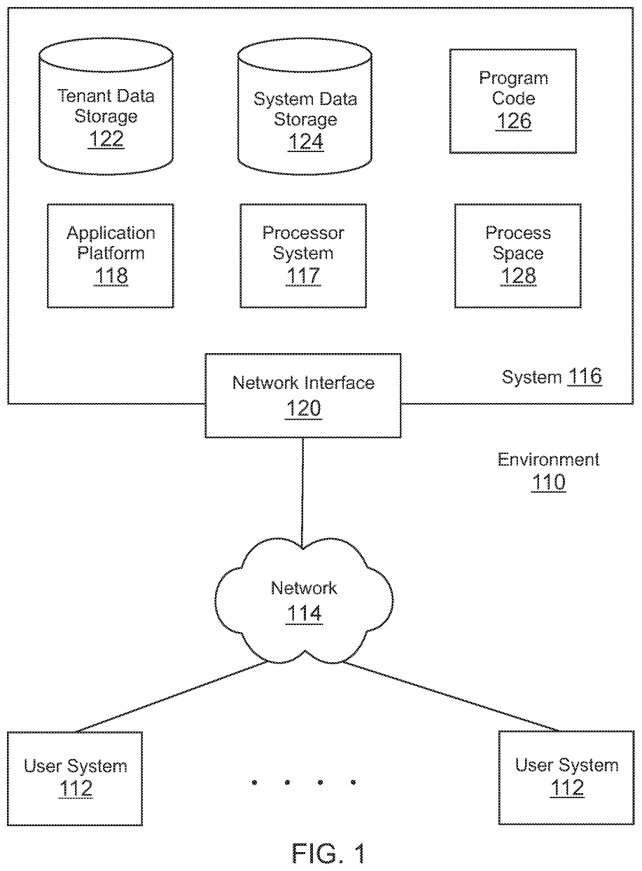

FIG. 1 illustrates a block diagram of an example environment 110 according to some embodiments. Environment 110 may include user systems 112, network 114, system 116, processor system 117, application platform 118, network interface 120, tenant data storage 122, system data storage 124, program code 126, and process space 128 for executing database system processes and tenant-specific processes, such as running applications as part of an application hosting service. In other embodiments, environment 110 may not have all of the components listed and/or may have other elements instead of, or in addition to, those listed above.

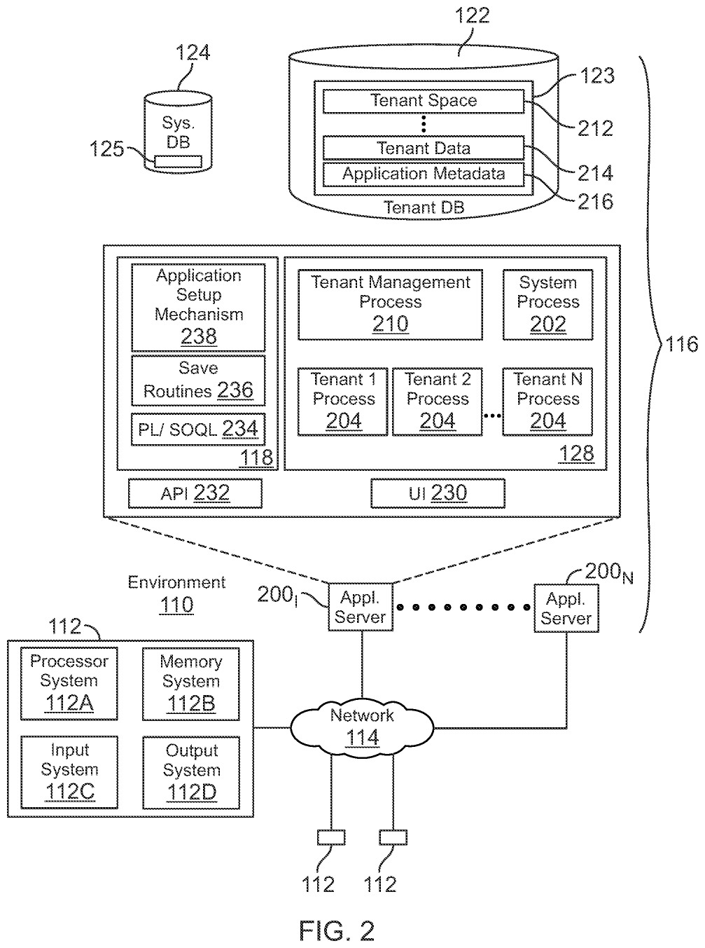

In some embodiments, environment 110 is an environment in which an on-demand database service exists. A user system 112 may be any machine or system that is used by a user to access a database user system. For example, any of user systems 112 can be a handheld computing device, a mobile phone, a laptop computer, a notepad computer, a workstation, and/or a network of computing devices. As illustrated in FIG. 1 (and in more detail in FIG. 2) user systems 112 might interact via a network 114 with an on-demand database service, which is system 116.

An on-demand database service, such as that which can be implemented using system 116, is a service that is made available to users outside of the enterprise(s) that own, maintain or provide access to system 116. As described above, such users do not need to necessarily be concerned with building and/or maintaining system 116. Instead, resources provided by system 116 may be available for such users' use when the users need services provided by system 116—e.g., on the demand of the users. Some on-demand database services may store information from one or more tenants stored into tables of a common database image to form a multi-tenant database system (MTS). Accordingly, the “on-demand database service 116” and the “system 116” will be used interchangeably herein. The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image may include one or more database objects. A relational data base management system (RDBMS) or the equivalent may execute storage and retrieval of information against the data base object(s).

Application platform 118 may be a framework that allows the applications of system 116 to run, such as the hardware and/or software infrastructure, e.g., the operating system. In an embodiment, system 116 may include application platform 118 that enables creating, managing, and executing one or more applications developed by the provider of the on-demand database service, users accessing the on-demand database service via user systems 112, or third-party application developers accessing the on-demand database service via user systems 112.

The users of user systems 112 may differ in their respective capacities, and the capacity of a particular one of user systems 112 might be entirely determined by permissions (permission levels) for the current user. For example, where a salesperson is using a particular user system 112 to interact with system 116, that user system has the capacities allotted to that salesperson. However, while an administrator is using that user system 112 to interact with system 116, that user system 112 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 114 is any network or combination of networks of devices that communicate with one another. For example, network 114 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the “Internet” with a capital “I” that network will be used in many of the examples herein. However, it should be understood that the networks that the present embodiments might use are not so limited, although TCP/IP is a frequently implemented protocol.

User systems 112 might communicate with system 116 using TCP/IP and, at a higher network level, use other common Internet protocols to communicate. Such as hypertext transfer protocol (HTTP), file transfer protocol (FTP), Andrew file system (AFS), wireless application protocol (WAP), etc. In an example where HTTP is used, user system 112 might include an HTTP client commonly referred to as a “browser” for sending and receiving HTTP messages to and from an HTTP server at system 116. Such an HTTP server might be implemented as the sole network interface between system 116 and network 114, but other techniques might be used as well or instead. In some implementations, the interface between system 116 and network 114 includes load sharing functionality, such as round-robin HTTP request distributors to balance loads and distribute incoming HTTP requests evenly over a plurality of servers. At least for the users that are accessing that server, each of the plurality of servers has access to the MTS data; however, other alternative configurations may be used instead.

In some embodiments, system 116, shown in FIG. 1, implements a web-based CRM system. For example, in one embodiment, system 116 includes application servers configured to implement and execute CRM software applications as well as provide related data, code, forms, webpages and other information to and from user systems 112 and to store to, and retrieve from, a database system related data, objects, and web page content. With a multi-tenant system, data for multiple tenants may be stored in the same physical database object. However, tenant data typically is arranged so that data of one tenant is kept logically separate from that of other tenants so that one tenant does not have access to another tenant's data, unless such data is expressly shared. In certain embodiments, system 116 implements applications other than, or in addition to, a CRM application. For example, system 16 may provide tenant access to multiple hosted (standard and custom) applications, including a CRM application. User (or third-party developer) applications, which may or may not include CRM, may be supported by application platform 118, which manages creation, storage of the applications into one or more database objects, and executing of the applications in a virtual machine in the process space of system 116.

One arrangement for elements of system 116 is shown in FIG. 1, including network interface 120, application platform 118, tenant data storage 122 for tenant data 123, system data storage 124 for system data 125 accessible to system 116 and possibly multiple tenants, program code 126 for implementing various functions of system 116, and process space 128 for executing MTS system processes and tenant-specific processes, such as running applications as part of an application hosting service. Additional processes that may execute on system 116 include database indexing processes.

Several elements in the system shown in FIG. 1 include conventional, well-known elements that are explained only briefly here. For example, each of user systems 112 could include a desktop personal computer, workstation, laptop, notepad computer, PDA, cell phone, or any wireless access protocol (WAP) enabled device or any other computing device capable of interfacing directly or indirectly to the Internet or other network connection. Each of user systems 112 typically runs an HTTP client, e.g., a browsing program, such as Microsoft's Internet Explorer browser, Netscape's Navigator browser, Opera's browser, or a WAP-enabled browser in the case of a cell phone, notepad computer, PDA or other wireless device, or the like, allowing a user (e.g., subscriber of the multi-tenant database system) of user systems 112 to access, process, and view information, pages, and applications available to it from system 116 over network 114. Each of user systems 112 also typically includes one or more user interface devices, such as a keyboard, a mouse, trackball, touch pad, touch screen, pen or the like, for interacting with a graphical user interface (GUI) provided by the browser on a display (e.g., a monitor screen, liquid crystal display (LCD) monitor, light emitting diode (LED) monitor, organic light emitting diode (OLED) monitor, etc.) in conjunction with pages, forms, applications, and other information provided by system 116 or other systems or servers. For example, the user interface device can be used to access data and applications hosted by system 116, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each of user systems 112 and all of its components are operator configurable using applications, such as a browser, including computer code run using a central processing unit such as an Intel Pentium® processor or the like. Similarly, system 116 (and additional instances of an MTS, where more than one is present) and all of their components might be operator configurable using application(s) including computer code to run using a central processing unit such as processor system 117, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 116 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

According to one embodiment, system 116 is configured to provide webpages, forms, applications, data and media content to the user (client) systems 112 to support the access by user systems 112 as tenants of system 116. As such, system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., object-oriented data base management system (OODBMS) or rational database management system (RDBMS)) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 110, which may be used to implement embodiments described herein. FIG. 2 further illustrates elements of system 116 and various interconnections, according to some embodiments. FIG. 2 shows that each of user systems 112 may include a processor system 112A, a memory system 112B, an input system 112C, and an output system 112D. FIG. 2 shows network 114 and system 116. FIG. 2 also shows that system 116 may include tenant data storage 122, tenant data 123, system data storage 124, system data 125, a user interface (UI) 230, an application program interface (API) 232, a PL/Salesforce.com object query language (PL/SOQL) 234, save routines 236, an application setup mechanism 238, applications servers 200₁-200_{N}, a system process space 202, tenant process spaces 204, a tenant management process space 210, a tenant storage area 212, a user storage 214, and application metadata 216. In other embodiments, environment 110 may not have the same elements as those listed above and/or may have other elements instead of, or in addition to, those listed above.

User systems 112, network 114, system 116, tenant data storage 122, and system data storage 124 were discussed above in FIG. 1. Regarding user systems 112, processor system 112A may be any combination of one or more processors. Memory system 112B may be any combination of one or more memory devices, short-term, and/or long-term memory. Input system 112C may be any combination of input devices, such as one or more keyboards, mice, trackballs, scanners, cameras, and/or interfaces to networks. Output system 112D may be any combination of output devices, such as one or more monitors, printers, and/or interfaces to networks. As shown in FIG. 2, system 116 may include network interface 120 (of FIG. 1) implemented as a set of HTTP application servers 200, application platform 118, tenant data storage 122, and system data storage 124. Also shown is system process space 202, including individual tenant process spaces 204 and tenant management process space 210. Each application server 200 may be configured to access tenant data storage 122 and tenant data 123 therein, and system data storage 124 and system data 125 therein to serve requests of user systems 112. Tenant data 123 might be divided into individual tenant storage areas 212, which can be either a physical arrangement and/or a logical arrangement of data. Within each tenant storage area 212, user storage 214 and application metadata 216 might be similarly allocated for each user. For example, a copy of a user's most recently used (MRU) items might be stored to user storage 214. Similarly, a copy of MRU items for an entire organization that is a tenant might be stored to the tenant storage area 212. UI 230 provides a user interface, and API 232 provides an application programmer interface, to system 116 resident processes and to users and/or developers at user systems 112. The tenant data and the system data may be stored in various databases, such as one or more Oracle™ databases.

Application platform 118 includes an application setup mechanism 238 that supports application developers' creation and management of applications, which may be saved as metadata into tenant data storage 122 by save routines 236 for execution by subscribers as one or more tenant process spaces 204 managed by tenant management process space 210, for example. Invocations to such applications may be coded using PL/SOQL 234 that provides a programming language style interface extension to API 232. Some embodiments of PL/SOQL language are discussed in further detail in U.S. Pat. No. 7,730,478, filed Sep. 21, 2007, entitled, “Method and System For Allowing Access to Developed Applications Via a Multi-Tenant On-Demand Database Service,” which is incorporated herein by reference. Invocations to applications may be detected by one or more system processes, which manage retrieving application metadata 216 for the subscriber, making the invocation and executing the metadata as an application in a virtual machine.

Each application server 200 may be communicably coupled to database systems, e.g., having access to system data 125 and tenant data 123, via a different network connection. For example, one application server 200₁ might be coupled via network 114 (e.g., the Internet), another application server 200_{N-1} might be coupled via a direct network link, and another application server 200_{N} might be coupled by yet a different network connection. Transfer Control Protocol and Internet Protocol (TCP/IP) are typical protocols for communicating between application servers 200 and the database system. However, it will be apparent to one skilled in the art that other transport protocols may be used to optimize the system depending on the network connection used.

In certain embodiments, each application server 200 is configured to handle requests for any user associated with any organization that is a tenant. Because it is desirable to be able to add and remove application servers from the server pool at any time for any reason, there is preferably no server affinity for a user and/or organization to a specific application server 200. In one embodiment, therefore, an interface system implementing a load balancing function (e.g., an F5 Big-IP load balancer) is communicably coupled between application servers 200 and user systems 112 to distribute requests to application servers 200. In one embodiment, the load balancer uses a least connections algorithm to route user requests to application servers 200. Other examples of load balancing algorithms, such as round robin and observed response time, also can be used. For example, in certain embodiments, three consecutive requests from the same user could hit three different application servers 200, and three requests from different users could hit the same application server 200. In this manner, system 116 is multi-tenant, wherein system 116 handles storage of, and access to, different objects, data and applications across disparate users and organizations.

As an example of storage, one tenant might be a company that employs a sales force where each salesperson uses system 116 to manage his or her sales process and/or provide information to other users, agents, and administrators, which may be searchable. Thus, a user might maintain contact data, leads data, customer follow-up data, performance data, goals and progress data, training material, research articles, etc., all applicable to that user (e.g., in tenant data storage 122). In an example of a MTS arrangement, since all of the data and the applications to access, view, modify, report, transmit, calculate, etc., can be maintained and accessed by a user system having nothing more than network access, the user can manage his or her information from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 116 that are allocated at the tenant level while other data structures might be managed at the user level. Because an MTS might support multiple tenants including possible competitors, the MTS should have security protocols that keep data, applications, and application use separate. Also, because many tenants may opt for access to a MTS rather than maintain their own system, redundancy, up-time, and backup are additional functions that may be implemented in the MTS. In addition to user-specific data and tenant specific data, system 116 might also maintain system level data usable by multiple tenants or other data. Such system level data might include industry reports, news, postings, and the like that are sharable among tenants.

In certain embodiments, user systems 112 (which may be client systems) communicate with application servers 200 to request and update system-level and tenant-level data from system 116 that may require sending one or more queries to tenant data storage 122 and/or system data storage 124. System 116 (e.g., an application server 200 in system 116) automatically generates one or more structured query language (SQL) statements (e.g., one or more SQL queries) that are designed to access the desired information. In other embodiments, such as a natural language processor or machine learning engine, other types of searches may be performed based on input data. System data storage 124 may generate query plans to access the requested data from the database, which may include external objects based on references to the objects within a document.

In a database system, such as system 116 shown and described with respect to FIGS. 1 and 2, data or information may be organized or arranged in categories or groupings. Each database can generally be viewed as a collection of objects, such as a set of logical tables, containing data fitted into predefined categories. A “table” is one representation of a data object and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields.

In an encyclopedic and/or CRM system, for example, these categories or groupings can include various standard tables associated with corpora of documents, such as listings of documents belong to a corpus, as well as information associated with searching those corpora submitted to the system (e.g., encoded documents, abstracts, ToCs, textual passages, and additional aforementioned document text). For example, a database may include a table that describes a corpus of documents (e.g., one or more documents that may be searched for a subject or the system itself) and may include this text of the documents within the corpora. In some multi-tenant database systems, tables and documents in a database might be provided for use by all tenants or may be only viewable by some tenants and agents (e.g., users and administrators) of the system.

In some multi-tenant database systems, tenants may be allowed to create and store custom objects, or they may be allowed to customize standard entities or objects, for example by creating custom fields for standard objects, including custom index fields. Systems and methods for creating custom objects as well as customizing standard objects in a multi-tenant database system are described in further detail in U.S. Pat. No. 7,779,039, filed Apr. 2, 2004, entitled “Custom Entities and Fields in a Multi-Tenant Database System,” which is incorporated herein by reference. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Multi-tenant database system 116 described above may be accessed and used by a number of customers, clients, or other persons (generally, “users”), regarding searching and/or browsing of an encyclopedic entry, inquiry, problem, question, issue, support-related matter, training or education, etc. However, in other embodiments, other types of search systems may also utilize the processes described herein to provide dense hierarchical retrieval of semantic-based passages in documents. To facilitate interaction between system 116 and the user, a search bar, voice interface, or similar user interface tool is provided. The search tool allows a user to query the database(s) to access information or data concerning or relating to various documents, objects, and/or entities relevant to the user.

For large databases with many records and information, however, there may be large amounts of documents where some or all of the documents include one or more document structures (e.g., an abstract, a ToC, sections and corresponding section titles, subsections and corresponding subsection titles, tables of titles, and/or the like) and passages (e.g., paragraphs, sentences, and/or other text). For example, a document may include document structures designating sections and passages and corresponding text for passages. When searching the document, conventional search techniques for open-domain QA (e.g., a machine learning system trained using character or word embeddings or vectors) may only search the content of the document by splitting passages in documents and encoding questions and passages for searching. Thus, a database system's search index data may not be an accurate basis to predict proper search results for a search query when not considering documents and document structures in addition to passages. It is a difficult task to predict and order search results for searches performed by users on large corpora of documents. In a multi-tenant system, such as Salesforce.com, documents may include document structures, passages, and the like. Continuing with the example, because the user may be most interested in relevant search results for a query having all returned data, for optimal or enhanced user experience, it may be desirable or preferable that the database system predict the documents that are most relevant or applicable to a user's search or query so that the desired information or data is presented to the user in the fewest number of keystrokes, mouse clicks, user interfaces, etc. As such, according to some embodiments, systems and methods are provided for predicting and returning search results using one or more dense hierarchical retrieval models that may include a document-level retrieval model and encoder and a passage-level retrieval model and encoder.

### Dense Hierarchical Retrieval Model

According to some embodiments, in a multi-tenant database system accessible by a plurality of separate and distinct organizations, such as system 116 shown and described with respect to FIGS. 1 and 2, a dense hierarchical retrieval model is provided for an intelligent search process which provides results returned that are most relevant for a given query into the database, taking into account the document-level data and structures with the passage-level data of documents of a corpus or corpora, thereby providing for enhanced user experience.

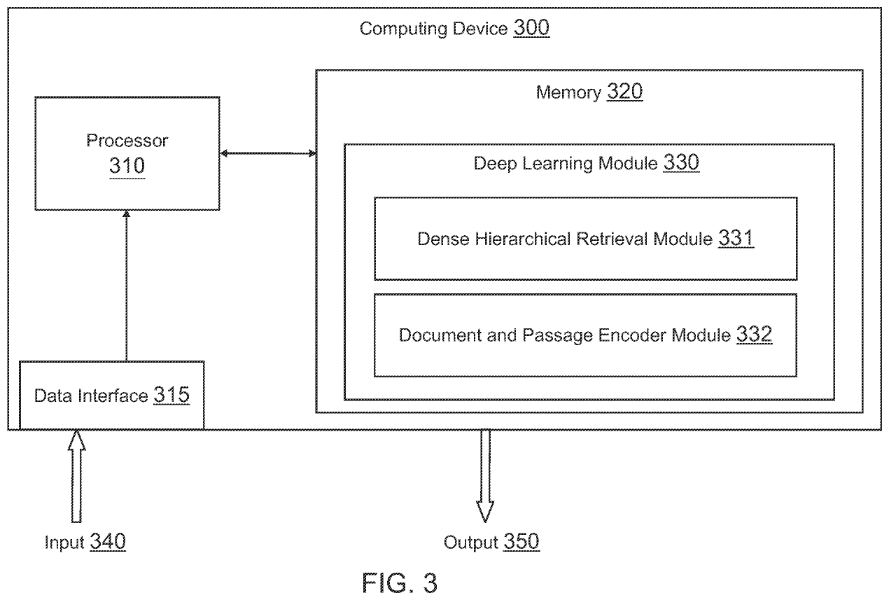

FIG. 3 is a simplified diagram of a computing device that implements a hierarchical retrieval of semantic based training data for deep learning, according to some embodiments described herein. As shown in FIG. 3, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In some examples, memory 320 may include non-transitory, tangible, machine readable media and/or a medium that includes executable code that when run by one or more processors (e.g., processor 310) may cause the one or more processors to perform the methods described in further detail herein. For example, as shown, memory 320 includes instructions for a deep learning module 330 that may be used to implement and/or emulate the systems and models, and/or to implement any of the methods described further herein. In some examples, deep learning module 330, may receive an input 340, e.g., such as a question for corpus of documents, via a data interface 315. Deep learning module 330 may also receive and/or access one or more corpora of documents for the question. Data interface 315 may be any of a user interface that receives a question for a QA dataset, or a communication interface that may receive or retrieve a previously requested question from another system and/or stored by a database. Deep learning module 330 may generate an output 350, such as an answer result from a corpus of documents based on a question of input 340. The answer result may include one or more documents and/or passages from the documents determined using deep learning module 330, which may be ranked, listed, categorized, and/or scored based on their relevance to the question determined using a document-level retrieval model and a passage-level retrieval model.

In some embodiments, deep learning module 330 may further includes a dense hierarchical retrieval module 331 and a document and passage encoder module 332. Dense hierarchical retrieval module 331 and document and passage encoder module 332 may be used to provide a better result to an open-domain question by using a DHR methodology that considers the question using a dense document-level retrieval model in combination with a dense passage-level retrieval model. A question for open-domain QA on a corpus of documents may be received and encoded by dense hierarchical retrieval module 331 for a corpus of documents identified for searching using the question. The dense document-level retrieval model may use encoded documents (e.g., based on their abstract, ToC, and/or other document structure) that are encoded and indexed by document and passage encoder module 332. Dense hierarchical retrieval module 331 may utilize document and passage encoder module 332 to identify one or more documents having passages from a corpus of documents. Unrelated documents may be filtered by dense hierarchical retrieval module 331 and one or more documents for searching and/or ranking may be identified.

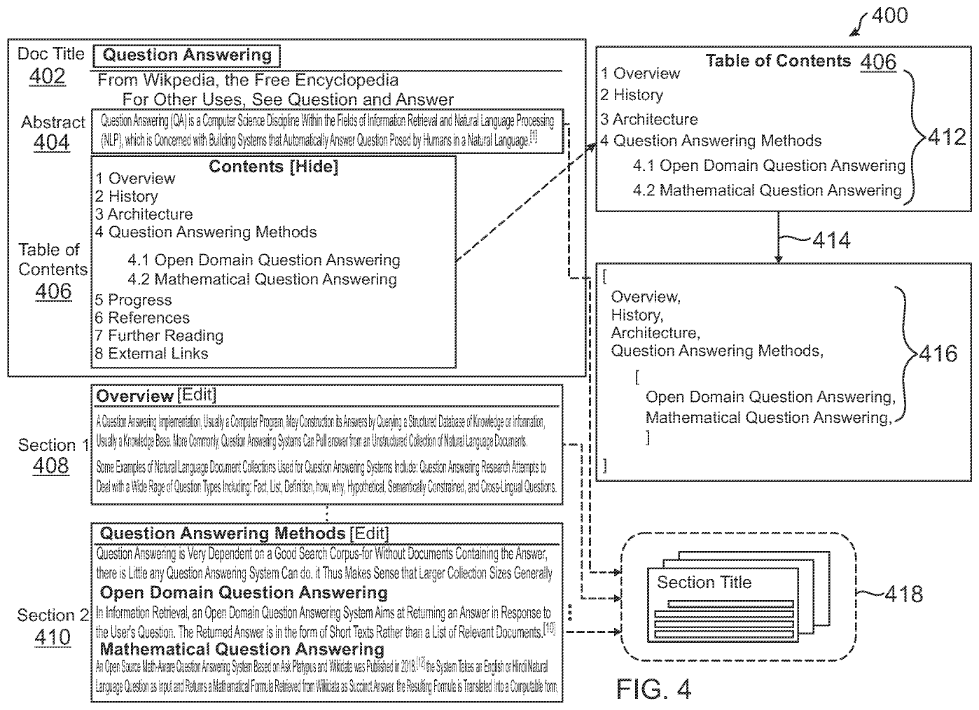

The dense passage-level retrieval model of document and passage encoder module 332 may be used when encoding passages from the document(s) identified from the document-level retrieval model and the encoded question. The encoded passages and question may be used by the dense passage-level retrieval model to obtain top-rated passages from top-rated documents, which are scored or ranked for return to the question from the open-domain QA on the corpus of documents. The relevance score of returned documents and/or passages may be determined based on combination relevance scores of document relevance scores from the dense document-level retrieval model and passage relevance scores from the dense passage-level retrieval model. Further functionality of dense hierarchical retrieval module 331 and document and passage encoder module 332 are discussed in further detail with regard to FIGS. 4-6. In some examples, deep learning module 330 and sub-modules 331-332 may be implemented using hardware, software, and/or a combination of hardware and software.

According to some embodiments, the functionality of computing device 300, including deep learning module 330, may be implemented or incorporated in a Search Model Service (SMS) plugin. SMS is a gRPC microservice that hosts and executes machine learning models. SMS takes in parameters via a Protobuf file, and executes models using those input parameters. SMS returns a response back to the client (e.g., user device) according to the response parameters defined. In some embodiments, the SMS implementation runs on an environment for containerized applications (e.g., Salesforce Application Model (SAM)) that is separate or independent from the core applications of the multi-tenant database system, such as system 116. SMS may provide for faster deployment of the model. SMS also provides for isolation/containerization of Java virtual machines (JVMs), so that a crash related to its model execution will not impact or affect the application servers of the database system. The SMS plugin is isolated code that can initialize the model data for a particular model type, perform model-specific feature processing, and execute model based on feature vectors and other parameters. The plugin architecture provides various advantages, including that changes can be made to plugin code without making changes to model executor code, and that concerns about load balancing, routing, and parallelizing are reduced or eliminated with plugins.

FIG. 4 illustrates a simplified diagram of an exemplary document and passages in a corpus of documents that may be retrieved using hierarchical retrieval of semantic-based passages in deep learning according to some embodiments. A document 400 in FIG. 4 displays document structures and structural elements that constitute a document having passages of text in a corpus of documents, such as articles, encyclopedic entries, training material, customer help requests and answers, and other documents in a database system. Thus, document 400 may be used to generate a document encoding based on one or more document structures, as well as passage encodings from short length split passages of text within the paragraphs of document 400.

Document 400 includes a document title 402, an abstract 404, a table of contents (ToC) 406, a first section 408, and a second section 410. Document 400 may correspond to a document within a corpus of documents, such as an encyclopedic entry for an online encyclopedia or other searchable database and platform. In this regard, document 400 may be viewed as a structural document, where different inputs and data is extracted and used as input for a document-level retrieval model and a passage-level retrieval model. These models for DHR may be used to determine a combination of relevance scores to better retrieve, score, and/or rank documents and passages for a question submitted for open-domain QA. In this regard, for document-level retrieval of documents from the corpus, the dense document-level retrieval model may utilize encoded documents from an index. The encoded documents may be encoded from the corpus of documents based on one or more document structures and may be indexed in an offline environment. Thus, when a question is submitted and queried in runtime, the index may be accessed and used with an encoding of the question for document-level retrieval.

For document-level retrieval, one or more document structures are required to be encoded for each of the documents in the corpus of documents. Encoding may correspond to creating an embedding or vector representation (e.g., having n-features, variables, or attributes) that represents the document based on the component parts of the document structure(s) used to encode the document. In this regard, document 400 includes ToC 406 that may correspond to a document structure used to encode document 400 for document-level retrieval. In some embodiments, document title 402 and/or abstract 404 may also be used for the document-level retrieval encoding. Document 400 further includes abstract 404, first section 408, and second section 410 that may be used when encoding passages of document 400 for passage-level retrieval.

ToC 406 includes a section and/or subsection title list 412, which is then extracted and cleaned using an extraction operation 414 to generate a hierarchical title list 416. Hierarchical title list 416 may then be used for encoding document 400 for a document-level retrieval model and document-level retriever when a question is queried and encoded. Thus, each document may be viewed as a structural collection having sections S, subsections Ss, and their corresponding paragraphs. Each section or subsection has a corresponding title. Thus, each document Dᵢ may also contain its own nested table of titles [[T_{S1}[T_{Ss1}; . . . ; TSsn]]; . . . ; [T_{Sm}[T_{Ss1}; . . . ; T_{Ssl}]]]. T_{D} may be viewed as the unique identity to distinguish documents in the corpus.

Further to perform passage-level retrieval for document 400, abstract 404, first section 408, second section 410, and/or other text of document 400 may be split into short length passages. In this regard, in-section split passage text 418 may be generated when splitting abstract 404, first section 408, and second section 410 into short length passages. This may be done by only splitting the paragraphs under the same section or subsection title into limited length passages. Each passage may correspond to a sequence of tokens with a nested title. There may be M total passages in a corpus C={P₁; P₂; . . . ; P_{M}} and, for each passage Pᵢ, the corresponding document that it belongs to may be determined by looking at the T_{D}. Thus, if f:p→d is defined as a function that maps a given passage p to its document d, then g:d→P maps a given document d to its passages P. The passages generated from abstract 404, first section 408, and second section 410 further include section title information and, during training, in-Doc and/or in-Sec negative training may be used to train the passage-level retrieval model. Extraction of hierarchical title list 416 and/or in-section split passage text 418 may use WikiExtractor code to extract the clean text-portion of articles and remove semi-structured data, such as tables, infoboxes, lists, and/or disambiguation pages. However, hierarchical title list 416 is retained for document 400. Further, the text under the same section may be concatenated and each section may be split into multiple, disjoint text blocks with maximum length not over 100 words.

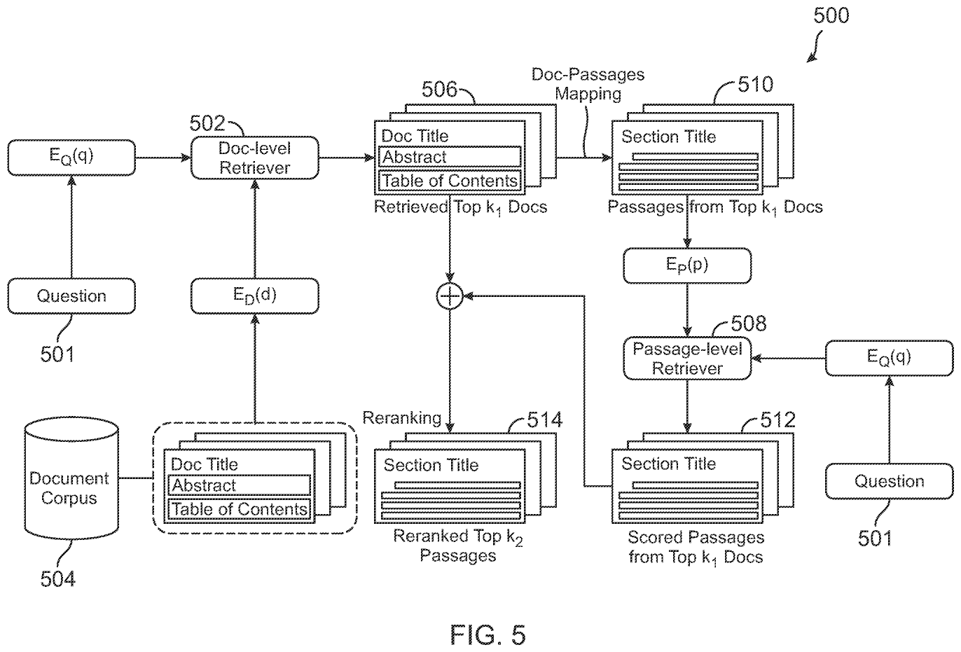

FIG. 5 illustrates a simplified diagram of exemplary components for hierarchical retrieval of semantic-based passages in deep learning according to some embodiments. In some embodiments, dense hierarchical retrieval using dense document-level and dense passage-level retrieval models in FIG. 5 can be an implementation of deep learning module 330 of computing device 300.

Components 500 of FIG. 5 may correspond to a system diagram for dense hierarchical retrieval of semantic-based features and passages from a corpus of documents using document-level and passage-level retrieval models. For example, a question 501 may be provided for an open-domain QA system and may be encoded as E_{Q}(q) using a question encoder. In order to provide better searching for question 501, a document-level retriever 502 may be used, which may correspond to the document-level retrieval model used with encoded documents E_{D}(d) (e.g., based on their encoded document structures and elements). The documents may correspond to those in a corpus of documents 504, which may be retrieved using document-level encoding and/or embeddings of the documents. Corpus of documents 504 may correspond to a large set of documents that may include different subject documents. Within corpus of documents 504, each document is associated with passages, which may be broken up from corpus of documents 504 for further passage-level encoding of the passage-level retrieval model.

Top k₁ documents 506 are determined based on the document-level retrieval model from the encoded documents and question. Unrelated documents may be filtered and one or more top rated or ranked documents may be returned based on the trained model for document-level retriever 502. Once top k₁ documents 506 are determined, passage-level retriever 508 may execute a passage-level retrieval model to determine top ranked or rated passages from those documents. However, first a document-passages mapping may be utilized to determine passages mapped to the encoded documents that were retrieved for top k₁ documents 506. The mapped passages may be identified as passages from top k₁ documents 510. Once passages from top k₁ documents 510 are determined, these passages may be encoded and provided to passage-level retriever 508.

The encoding of question 501 may also be used with passage-level retriever 508, where passages from top k₁ documents 510 are encoded in order for the passage-level retrieval model to determine scored passages from top k₁ documents 512. Once the model of pas sage-level retriever 508 is applied to the encoded passages E_{P}(p) from passages from top k₁ documents 510, scored passages from top k₁ documents 512 may then be determined as a smaller filtered subset of the documents and corresponding passages that may be relevant to question 501. However, as the relevance scores of top k₁ documents 506 determined from the document-level retrieval model may be relevant to the ranking and output of the documents and passages, a reranking may be performed that combines the relevance scores of top k₁ documents 506 and the relevance scores of scored passages from top k₁ documents 512. The reranking may combine the scores to obtain reranked top k₂ passages 514 based on a combination relevance score from document-level retriever 502 and passage-level retriever 508. This allows for DHR using both document-level retrieval and passage-level retrieval models to search question 501 with corpus of documents 504.

In order to train the models of document-level retriever 502 and passage-level retriever 508 and generate the encodings for encoded documents E_{D}(d) and encoded passages E_{P}(p), training operations may be executed for DHR. In some embodiments, the first section of documents within the corpus of documents may be the description and/or summary of the document that contains information central to the topic in the document, such as an encyclopedic entry. This may include an abstract, and the document may further include a ToC that highlights the sections and subsections within the document. A nested table of contents may be linearized as [[T_{S1}[T_{Ss1}; . . . ; T_{Ssn}]]; . . . ; [T_{Sm}[T_{Ss1}; . . . ; T_{Ssl}]]] by using a comma or the special token [SEP] as T_{table}=T_{S1}, T_{Ss1}, . . . , T_{Ssl} or T_{table}=T_{S1}[SEP] T_{Ss1} [SEP] . . . [SEP] T_{Ssl}. The final document D may be represented as [CLS] T_{D} [SEP] W_{D} [SEP] T_{table} [SEP].

Dense document-level retrieval may use a question encoder and a document encoder based on Bidirectional Encoder Representations from Transformers (BERT) deep NN model. BERT corresponds to a language representation deep learning model that allows training of deep bidirectional representations in NN model layers. Questions and documents may be encoded as dense representation vectors and the relevance score of a document to a question may be computed by the dot product: Sim (q, d)= [symbol] E_{Q}(q), E_{D}(d) [symbol] where q and d may be low dimensional vectors from the question and document encoding, respectively, and [symbol] . [symbol] may represent the dot product.

When training the encoder(s) of the dense document-level retrieval model, QA data sets for training data may be used. These may include standardized open-domain QA evaluation data sets including Natural Questions (NQ) having questions mined from real Google® searches and their corresponding answers in encyclopedic articles identified by annotators, TriviaQA having a set of trivia questions with answers that were scraped from the web, WebQuestions having questions selected using Google® Suggest API and answers corresponding to entities in Freebase, and/or CuratedTREC (TREC) having questions from TREC QA tracks as well as various web sources intended for open-domain QA from unstructured text. When selecting positive passages, pairs of questions and answers may be provided in TREC and TriviaQA. Therefore, the highest-ranked passage determined using a deep learning model for Best Match 25 (BM25) that contains the answer may correspond to the positive passage. If none of the top one hundred retrieved passages includes the answer, the question may be discarded. Further, negative sampling and training on negative documents and passages (e.g., those appearing as positive passages but not including the answer) may also be used for model training, where rankings of passages may affect training of the dense model based on the training data. This may include use of in-Doc and in-Sec negatives for passages, which may be more biased or heavily weighted based on a closeness of the in-Doc and/or in-Sec negatives to a positive passage that includes the answer.

For example, when training data sets, in the datasets containing the gold title (e.g., that title having a positive and/or best match) to a given question, the positive documents may be the documents having the gold title. In the other datasets, when using BM25 the Top-1 document is retrieved that contains the answer in the whole document text as the positive document. Thereafter for training, three different types of negatives may be used. Intro negative may use a first section to represent each document and BM25 may then be used to retrieve the top documents, but which do not contain the answer in the whole document text. All-text negative may use the entire document text to represent each document and BM25 may then be used to retrieve the top documents, but which do not contain the answer in the whole document text. Further, in-batch negatives may be used from passages paired with other questions appearing in the training data set.

Passage-level retriever 508 may further require encoding of passages using the passage-level retrieval model trained for passage-level retrieval. When training the encoder(s) of the dense passage-level retrieval model, a subtitle list (e.g., section and/or subsection title list) may be considered with a document title. A passage P will be represented as [CLS] title [SEP] subtitle₁, subtitle₂, . . . , subtitleₙ [SEP] passage [SEP]. A different E_{Q}(.) may be used in dense document-level retrieval and dense passage-level retrieval models. Thus, a relevance score of a passage to a question may be computed by the dot product: Sim (q, d)= [symbol] E_{Q}(q), E_{D}(p) [symbol] where q and p may be low dimensional vectors from the question and passage encoding, respectively.

Positive and negative passages may be determined for training in a similar manner to dense passage retrieval (DPR). For example, in a dataset having the gold (e.g., best or top-1) context to a given question, a positive passage may be a mapping of the passage having the gold context in the passage set {P}. For other data sets, BM25 may be used to retrieve the top-1 passage containing the answer. BM25 negative and in-batch negatives may also be used. Further to improve model ability for finding the positive passage given the positive document from the document-level retrieval, in-Doc negatives and in-Sec negatives may be used for retrieved passages. An in-Doc negative may be passages that do not contain the answer in the same document as the positive passage, while an in-Sec negative may be the other passages that do not contain the answer in the same section as the positive passage

During inference time, document-level retriever 502 is therefore applied to select top k₁ documents 506. Using a document-passages mapping, the passages inside top k₁ documents 506 are sent to passage-level retriever 508 to determine scored passages from top k₁ documents 512, which are reranked using a combination of document and passage relevance scores to obtain reranked top k₂ passages 514. Prior to inference time, the document encoder E_{D} encodes the documents from corpus of documents 504, which are indexed offline. Given a question q at runtime, an embedding is derived and top k₁ documents 506 are retrieved with embeddings closest to question q. All the passages from top k₁ documents 506 are retrieved from the mappings and the passage encoder E_{P} is applied to all the retrieved passages. Scored passages from top k₁ documents 512 and the ranking or relevance scores from the document-level retrieval and passage-level retrieval are used to re-rank the passages.

Thus, the retrieval ranking and/or relevance scores from both the dense document retrieval and dense passage retrieval contribute to the final ranking of reranked top k₂ passages 514. To do this, the document relevance score is combined with the passage relevance score, calculated by: Sim (q, Dⱼ)+λ*Sim(q, Pᵢ), Pᵢ∈Dⱼ where λ is the coefficient used between the two scores. The scores may be substantially similar and therefore λ may be close or equal to 1. Further, iterative training may be applied to train both the document-level and passage-level retrieval models. For example, after an initial training, retraining using the data sets and positive/negatives may be used to further refine predictive decision-making and document/passage retrieval by the models.

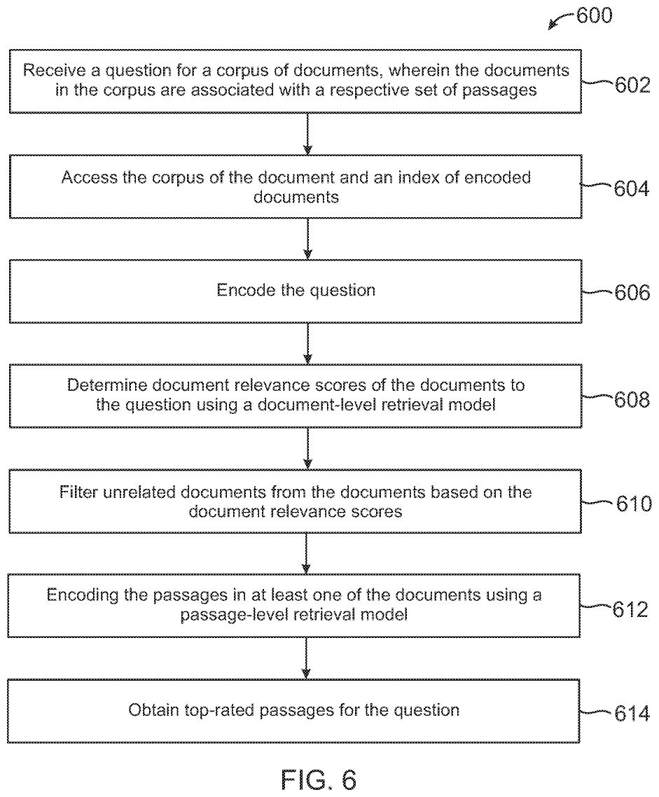

FIG. 6 illustrates a simplified diagram of a flowchart for hierarchical retrieval of semantic-based passages in deep learning using a document-level and passage-level retriever described in FIGS. 3, 4, and 5 according to some embodiments. One or more of processes 602-614 of method 600 may be implemented, at least in part, in the form of executable code stored on non-transitory, tangible, machine-readable media that when run by one or more processors may cause the one or more processors to perform one or more of processes 602-614. In some embodiments, method 600 can be performed by one or more computing devices in environment 110 of FIGS. 1 and 2.

The model(s) of deep learning module 330 uses data parsing, extracting, encoding, converting, and QA predicting processes to perform dense hierarchical retrieval of semantic-based passages and/or documents in a database system (e.g., system 116) based on document-level and passage-level retrieval models. In some embodiments, these include the documents and corpora of documents that may be standard for the database system (e.g., articles, encyclopedic entries, training material, customer help requests and answers, and other documents that may be relevant to a particular database system) and provided for customers of the CRM or other system.

To accomplish this, and with reference to FIGS. 4 and 5, method 600 starts with a process 602. At process 602, deep learning module 330 receives a question for a corpus of documents, wherein the documents in the corpus are associated with a respective set of passages. The corpus of documents may correspond to corpus of documents 504 and may include documents similar to document 400, such as informational articles, encyclopedic entries, help request, training manuals, pamphlets or other articles about a subject that provide information. Question 501 may correspond to an input question that is a query for open-domain QA. At process 604, the corpus of documents and an index of encoded documents are accessed. For example, a dense document-level retrieval model may be used to generate encodings of documents, including document 400 and/or from corpus of documents 504, which may be designated as E_{D}(d). In this regard, document-level retriever 502 may retrieve E_{D}(d) after encoding for the dense model.

At process 606, the question is encoded. Question 501 may be encoded as E_{Q}(q), which may be encoded using a question encoder that may be utilized with a document encoder generating E_{D}(d), for example, for document-level retriever 502. At process 608, document relevance scores of the documents to the question are determined using a document-level retrieval model. Document-level retriever may retrieve top k₁ documents 506 based on encoding E_{Q}(q) of question 501. The document relevance scores may correspond to scored, ranked, or otherwise weighted values for determining a relevance of top k₁ documents 506 to question 501. In this regard, top k₁ documents 506 may be scored and/or ordered based on their encodings, E_{D}(d), which may be determined from one or more document structures of document 400 and/or documents from corpus of documents 504.

At process 610, unrelated documents are filtered from the documents based on the document relevance scores. For example, top k₁ documents 506 may correspond to a filtered subset of the documents from corpus of documents 504 based on their corresponding relevance scores. Further, document-to-passages mapping may be required to determine passages from encoding E_{D}(d) of the documents in top k₁ documents 506. This allows a return of passages from top k₁ documents 510. At process 612, the passages in at least one of the documents (based on the filtered and returned documents and passages) are encoded using a passage-level retrieval model. Passage-level retrieval 508 may encode passages from top k₁ documents 510 to generate encoded passages E_{P}(p).

At process 614, top-rated passages are obtained for the question. Using encoded passages E_{P}(p) with E_{Q}(q) (e.g., the encoding of question 501), scored passages from top k₁ documents 512 may be returned by passage-level retrieval 508. This may be determined using the corresponding dense model based on the encodings of the question and passages. However, prior to returning just scored passages from top k₁ documents 512, relevance scores from top k₁ documents 506 and scored passages from top k₁ documents 512 may be combined and/or processed to obtain reranked top k₂ passages 514. These top ranked passages may then be provided as output for question 501 for open-domain QA on corpus of documents 504.

For the processes described above, one or more neural network models may be trained on the training data. In some embodiments, for training, the neural network may perform pre-processing on training data, for example, for each word, portion of a word, or character in a training text. The embeddings are encoded, for example, with one or more encoding layers of the neural network to generate respective vectors. A pre-processing layer generates an embedding for each word in the text input sequence. Each embedding can be a vector. In some embodiments, these can be word embeddings, such as obtained, for example, by running methods like word2vec, FastText, or GloVe, each of which defines a way of learning word vectors with useful properties. In some embodiments, pre-trained vectors of a certain dimensionality may be used. In some embodiments, the embedding may include partial word embeddings related to portions of a word. For example, the word “where” includes portions “wh,” “whe,” “her,” “ere,” and “re.” Partial word embeddings can help to enrich word vectors with subword information/FastText. Similarly, when applying the pre-processing layer to words and/or phrases from training data, a sequence of word vectors may be generated based on the sequences of words within the documents and document structures. In some instances, a text input sequence, e.g., used for training, may comprise few words, in which case, the embeddings output from the pre-processing layer can be “padded,” e.g., with zeros. A mask layer masks such numbers so that they are ignored or not processed in subsequent layers, for example, to help reduce training time.

The encoding layers learn high-level features from the words of textual input sequence. Each encoding layer generates encodings (e.g., vectors) which map the words in the text input sequence to a higher dimensional space. The encodings can encode the semantic relationship between words. In some embodiments, the encoding layers or encoder stack is implemented with a recurrent neural network (RNN). RNNs are deep learning models that process vector sequences of variable length. This makes RNNs suitable for processing sequences of word vectors. In some embodiments, the encoding layers can be implemented with one or more gated recurrent units (GRUs). A GRU is a specific model of recurrent neural network (RNN) that intends to use connections through a sequence of nodes to perform machine learning of tasks. GRUs help to adjust the neural network input weights to solve the vanishing gradient problem that is common issue with RNNs. In some embodiments, encoding layers can be implemented with one or more long-term short-term memory (LSTM) encoders.

A plurality of the GRUs may be arranged in rows. A first row of the GRUs looks at or operates on information (e.g., embeddings or encodings) for respective words in the text input sequence in a first (e.g., “forward”) direction, with each GRU generating a corresponding state vector and passing that vector along to the next GRU in the row (e.g., as indicated by the arrows pointing from left to right). A second row of GRUs looks at or operates on information (e.g., embeddings or encodings) for respective words in the input sequence in a second (e.g., “backward”) direction, with each GRU generating a corresponding hidden state vector and passing that vector along to the next GRU in the row. The weights (values) of the embedding matrix may be initialized at random and/or separately and updated/learned using backpropagation at training time.

According to some embodiments, embeddings may be learned end-to-end while training the machine learning engine and/or neural network model (with other features) on its classification task. The training will result in having one vector per character, word, phrase, or sentence, and cluster the vectors. For instance, two characters, words, phrases, or sentences having similar embeddings will end up having similar vectors, closer than distant embeddings. The embeddings are then flattened at a respective flattener and/or concatenated at a respective concatenator.

The model of the neural network is trained using the concatenated features or vectors. For training, the neural network may include or be implemented with a multi-layer or deep neural network or neural model, having one or more layers. According to some embodiments, examples of multi-layer neural networks include the ResNet-32, DenseNet, PyramidNet, SENet, AWD-LSTM, AWD-QRNN and/or the like neural networks. The ResNet-32 neural network is described in further detail in He, et al., “Deep Residual Learning for Image Recognition,” arXiv:1512.03385, submitted on Dec. 10, 2015; the DenseNet neural network is described in further detail in Iandola, et al., “Densenet: Implementing Efficient Convnet Descriptor Pyramids,” arXiv:1404.1869, submitted Apr. 7, 2014, the PyramidNet neural network is described in further detail in Han, et al., “Deep Pyramidal Residual Networks,” arXiv:1610.02915, submitted Oct. 10, 2016; the SENet neural network is described in further detail in Hu, et al., “Squeeze-and-Excitation Networks,” arXiv:1709.01507, Sep. 5, 2017; the AWD-LSTM neural network is described in further detail in Bradbury, et al., “Quasi-Recurrent Neural Networks,” arXiv:1611.01576, submitted on Nov. 5, 2016; each of which are incorporated by reference herein.

Each neural network layer can operate or process the features or vectors, performing, for example, regularization (e.g., L2 and L1 regularization, Early stopping, etc.), normalization, and activation. In some embodiments, each neural network layer may include a dense layer, batch normalization, and a dropout for deep learning. In some embodiments, a respective rectifier linear unit (ReLU) at the end of each layer performs a ReLU activation function. An output layer of the neural network performs a softmax function to produce or generate one single model for all contexts. The global model predicts case objects for present queries or a test case object into a database system, such as system 116. In some embodiments, the model comprises or represents a probability distribution for embeddings within a document and/or document structure (whether standard or custom) with respect to a given training document and/or document structure (e.g., corpus or corpora of documents having passages and document structures). For the distribution, each embedding has a corresponding numerical value representing or indicative of the relevance of that such embedding to the present search. In some embodiments, the softmax layer can be implemented with a high-rank language model, called Mixture of Softmaxes (MoS), to alleviate softmax bottleneck issues.

As discussed above and further emphasized here, FIGS. 3, 4, 5, and 6 are merely examples of deep learning module 330 and corresponding method 600 for training and use which should not unduly limit the scope of the claims. One of ordinary skill in the art would recognize many variations, alternatives, and modifications.

Some examples of computing devices, such as computing device 300, may include non-transitory, tangible, machine readable media that include executable code that when run by one or more processors (e.g., processor 310) may cause the one or more processors to perform the processes of method 600. Some common forms of machine-readable media that may include the processes of method 600 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications. Thus, the scope of the present application should be limited only by the following claims, and it is appropriate that the claims be construed broadly and in a manner consistent with the scope of the embodiments disclosed herein.

What is claimed is:

1. A system for dense hierarchical retrieval in deep learning, the system comprising:
a non-transitory memory storing machine executable code; and
one or more hardware processors coupled to the non-transitory memory and configurable to execute the machine executable code to cause the one or more hardware processors to perform operations comprising:
receiving a question for a corpus of documents, wherein the documents in the corpus are associated with a respective set of passages;
accessing the corpus of the documents and an index of encoded documents for the documents, wherein the encoded documents are based on at least one of abstracts for the documents or linearized tables of contents for the documents;
encoding the question for a document-level retrieval model for the documents and a passage-level retrieval model for the passages;
determining document relevance scores of the documents to the question using the document-level retrieval model, wherein the document relevance scores are based on the encoded question and the encoded documents;
filtering unrelated documents from the documents to identify at least one of the documents using the document relevance scores;
encoding the passages in the at least one of the documents using the passage-level retrieval model for the passages, wherein encoding the passages further uses at least one document structure for the at least one of the documents; and
obtaining top-rated passages for the question from the at least one of the documents using the document relevance scores and the encoded passages.

2. The system of claim 1, wherein obtaining the top-rated passages comprises:
determining passage relevance scores for the question using the passage-level retrieval model and the encoded passages; and
determining a filtered set of passages from the documents using a combination relevance score from the document relevance scores and the passage relevance scores.

3. The system of claim 1, wherein the passages are enhanced prior to encoding the passages with the at least one document structure, and wherein the at least one document structure comprises at least one of an abstract, a table of contents, one or more section titles, one or more subsection titles, or one or more paragraph title lists for a corresponding one of the documents.

4. The system of claim 1, wherein determining the document relevance scores are further based on a ranking of the passages for training data provided during a training of the document-level retrieval model.

5. The system of claim 1, wherein before receiving the question, the machine executable code further causes the one or more hardware processors to perform the operations comprising:
determining the at least one of the abstracts or the linearized tables of contents for the documents in the corpus;
encoding the documents using a first deep learning model based on the at least one of the abstracts or the linearized tables of contents; and
performing offline indexing of the encoded documents in the index.

6. The system of claim 5, wherein the machine executable code further causes the one or more hardware processors to perform the operations comprising:
retrieving a set of top passages for a training question using a second deep learning model; and
training the passage-level retrieval model using a negative sampling operation for in-document negative samples and in-section negative samples from the retrieved set of top passages for the training question.

7. The system of claim 6, wherein the negative sampling operation applies a weighted bias based on a closeness of a negative passage to a positive passage in a corresponding document or a corresponding section from the retrieved set of top passages.

8. A method for dense hierarchical retrieval in deep learning, the method comprising:
receiving a question for a corpus of documents, wherein the documents in the corpus are associated with a respective set of passages;
accessing the corpus of the documents and an index of encoded documents for the documents, wherein the encoded documents are based on at least one of abstracts for the documents or linearized tables of contents for the documents;
encoding the question for a document-level retrieval model for the documents and a passage-level retrieval model for the passages;
determining document relevance scores of the documents to the question using the document-level retrieval model, wherein the document relevance scores are based on the encoded question and the encoded documents;
filtering unrelated documents from the documents to identify at least one of the documents using the document relevance scores;
encoding the passages in the at least one of the documents using the passage-level retrieval model for the passages, wherein encoding the passages further uses at least one document structure for the at least one of the documents; and
obtaining top-rated passages for the question from the at least one of the documents using the document relevance scores and the encoded passages.

9. The method of claim 8, wherein obtaining the top-rated passages comprises:
determining passage relevance scores for the question using the passage-level retrieval model and the encoded passages; and
determining a filtered set of passages from the documents using a combination relevance score from the document relevance scores and the passage relevance scores.

10. The method of claim 8, wherein the passages are enhanced prior to encoding the passages with the at least one document structure, and wherein the at least one document structure comprises at least one of an abstract, a table of contents, one or more section titles, one or more subsection titles, or one or more paragraph title lists for a corresponding one of the documents.

11. The method of claim 8, wherein determining the document relevance scores are further based on a ranking of the passages for training data provided during a training of the document-level retrieval model.

12. The method of claim 8, wherein before receiving the question, the method further comprises:
determining the at least one of the abstracts or the linearized tables of contents for the documents in the corpus;
encoding the documents using a first deep learning model based on the at least one of the abstracts or the linearized tables of contents; and
performing offline indexing of the encoded documents in the index.

13. The method of claim 12, further comprising:
retrieving a set of top passages for a training question using a second deep learning model; and
training the passage-level retrieval model using a negative sampling operation for in-document negative samples and in-section negative samples from the retrieved set of top passages for the training question.

14. The method of claim 13, wherein the negative sampling operation applies a weighted bias based on a closeness of a negative passage to a positive passage in a corresponding document or a corresponding section from the retrieved set of top passages.

15. A non-transitory machine-readable medium having stored thereon instructions configurable for performing a method for dense hierarchical retrieval in deep learning, the instructions comprising machine executable code to cause a machine to perform operations comprising:
receiving a question for a corpus of documents, wherein the documents in the corpus are associated with a respective set of passages;
accessing the corpus of the documents and an index of encoded documents for the documents, wherein the encoded documents are based on at least one of abstracts for the documents or linearized tables of contents for the documents;
encoding the question for a document-level retrieval model for the documents and a passage-level retrieval model for the passages;
determining document relevance scores of the documents to the question using the document-level retrieval model, wherein the document relevance scores are based on the encoded question and the encoded documents;
filtering unrelated documents from the documents to identify at least one of the documents using the document relevance scores;
encoding the passages in the at least one of the documents using the passage-level retrieval model for the passages, wherein encoding the passages further uses at least one document structure for the at least one of the documents; and
obtaining top-rated passages for the question from the at least one of the documents using the document relevance scores and the encoded passages.

16. The non-transitory machine-readable medium of claim 15, wherein obtaining the top-rated passages comprises:
determining passage relevance scores for the question using the passage-level retrieval model and the encoded passages; and
determining a filtered set of passages from the documents using a combination relevance score from the document relevance scores and the passage relevance scores.

17. The non-transitory machine-readable medium of claim 15, wherein the passages are enhanced prior to encoding the passages with the at least one document structure, and wherein the at least one document structure comprises at least one of an abstract, a table of contents, one or more section titles, one or more subsection titles, or one or more paragraph title lists for a corresponding one of the documents.

18. The non-transitory machine-readable medium of claim 15, wherein determining the document relevance scores are further based on a ranking of the passages for training data provided during a training of the document-level retrieval model.

19. The non-transitory machine-readable medium of claim 15, wherein before receiving the question, the instructions further cause the machine to perform the operations comprising:
determining the at least one of the abstracts or the linearized tables of contents for the documents in the corpus;
encoding the documents using a first deep learning model based on the at least one of the abstracts or the linearized tables of contents; and
performing offline indexing of the encoded documents in the index.

20. The non-transitory machine-readable medium of claim 19, wherein the instructions further cause the machine to perform the operations comprising:
retrieving a set of top passages for a training question using a second deep learning model; and
training the passage-level retrieval model using a negative sampling operation for in-document negative samples and in-section negative samples from the retrieved set of top passages for the training question.

21. The non-transitory machine-readable medium of claim 20, wherein the negative sampling operation applies a weighted bias based on a closeness of a negative passage to a positive passage in a corresponding document or a corresponding section from the retrieved set of top passages.
